(19) United States
(12) Patent Application Publication
(10) Pub. No.: US 2011/0110586 A1
(43) Pub. Date: May 12, 2011

(54) INFORMATION CODE

(75) Inventors: Yoshiyuki Takura, Chuo-ku (JP); Kenji Ichinose, Chuo-ku (JP); Tatahiro Miwa, Chuo-ku (JP)

(73) Assignee: Colour Code Technologies, Co., Ltd, Chuo-ku, Tokyo (JP)

(21) Appl. No.: 12/995,058

(22) PCT Filed: May 29, 2008
(86) PCT No.: PCT/JP2008/059885

§ 371 Date: Jan. 3, 2011

(51) Int. Cl. G06K 9/36

(52) U.S. Cl. 382/166

(57) ABSTRACT

An information code of the present inventioncomprises an excision code portion based on a code system which allows easy excision, by colorcomponent analysis, of a code area from an image data containing the code area, and a data recording code portion which is capable of recording target electronic data in high recording density, and can improve recording density of the data recording code portion by increasing the number of colors and/or reducing the cell size, by decoding of the excision code portion making possible also using mathematical calculation not solely depending on color component analysis. The present invention aims to provide the information code based on two codestandards for the excision code portion and the data recording code portion respectively. A code system that provides easy excision of a code by the color component analysis is adopted for the excision code because the excision code serves as an initial clue to excise a code from an image. By decoding of the excision code portion, information needed for extraction and decoding of the data recording code portion is obtained.

### TECHNICAL FIELD

The present invention relates to an information code that can store electronic data

### BACKGROUND ART

Various methods have been proposed for conversion of electronic data into information code, as well as for recording and restoration of the information code on and from a print medium. Specifically, those methods include: use of one-dimensional or two-dimensional bar-code which records information in a black-and-white pattern; and color code which uses colors such as red and blue.

However, the bar-code which records information in the black-and-white pattern provides poor record efficiency, so that it cannot store a large volume of electronic data such as image or voice.

To solve this issue, various types of color-coding systems, which aim to increase the recording density, have been proposed. However, a disadvantage of color code is that, if color detection of a reading unit varies, the corresponding data may then more possibly vary than the case with black-and-white code, making the color code to be susceptible to color fading, uneven print, illuminated light, etc., providing lesser restoration accuracy as compared with bar-code. Therefore, in actual usage environments of restoring, with a reading unit, color code recorded on a print medium, the above fact requires each cell to be made larger, or the number of usable colors to be limited to something like three or four. Color code has not achieved large recording density, as it was expected to be according to those proposals.

Generally, identification of a code and each cell is made by optical color difference, so that the greater the difference of the colors (color difference) being used is, the more difficult the identification becomes. Furthermore, effects of color fading, uneven print, illuminated light, etc., will change the color, so that the narrower the region of each color (color region in which the color is identified) being used becomes, the more possibly the color is identified as a different one. This means that the more the number of colors to be used becomes, the narrower the region of each color becomes, resulting in higher possibility of causing misidentification.

Generally, a camera or a scanner is used as a reading unit, into which an image, including a code, is read as digital data, which is then restored by analysis. However, although the image makes visually identifiable therefrom, it is no more than a digital aggregate of pixels holding color information in RGB values so that a code area is not distinguished from other regions. The color information (RGB values) is the only information source that can be used for digitally distinguishing the code area from the rest. Ideally, only a code area should be read when an image is read. However, in actual usage environments where ordinary image input devices, such as a digital camera, a web camera attached to or installed in a personal computer, or a scanner, are used, a code area alone is technically difficult to be read and this reading is not practical.

Depending on image-photographing environments, the same color as being used in a code may exist in a non-code area, or a shadow or a shifting light source may blur the boundary of codes or cells. If this is the case, it is difficult to identify the code or cell regions by color information alone. Further, increasing the number of colors to be used in a code for improvement of recording efficiency lessens the degree of color difference between colors, resulting in being easily affected by a shadow or a shifting light source; therefore the identification becomes even more difficult.

Every color has a wavelength, so what happens in a color boundary area is that different wavelengths are mixing with each other. Because in a code image read into from a print medium, the wavelength has been converted to a digital image, color information in a color boundary area are digital information mixed with neighboring colors each other. Therefore, gradation (gradual migration) state is likely to happen in a color boundary area. The smaller the size of a cell becomes, the more proximate the boundary of colors becomes, resulting that an mixed color pixel area expands, while a non-mixed pixel area is further lost.

The conventional method, which is dependent on color component analysis for extraction of a code area and identification of a color of each cell, requires so a great degree of color difference and a large cell size as to be free from effect of the color mixing. Therefore it is not a rational method for color codes, which aims at an improvement of recording efficiency by increasing the number of colors or by reduction of the cell size. Also, generally in many cases, the conventional method judges the color by analyzing the color information of all pixels constituting a cell. Handling the large volume of pixel information bears a load on processing, and requires time for restoration.

As described above, the conventional code system has a disadvantage that increasing the recording density on a print medium only decreases restoration accuracy, which fact makes this method not very practical for recording electronic data thereon. In actual usage environments where restoration accuracy is essential, only cells of practically usable size (specifications), which should be large enough to secure accuracy, are used. In order to make use of the information code as a method for recording electronic data on a print medium, a restoration-accuracy maintainable code system and method are needed even if the recording density is being increased.

Patent Document 1: Japanese Patent No. 3996520

### DISCLOSURE OF THE INVENTION

### Problems to be Solved by the Invention

In consideration of the above described conventional disadvantage, the present invention adopts an information code based on two code specifications that are the excision code portion and the data recording code portion, and the excision code portion provides easy excision of a code by analysis of color components because the excision code portion serves as an initial clue to excise a code from an image, and by decoding of the excision code, information needed for excision and decoding of the data recording code portion can be obtained. Accordingly, the present invention has a purpose to provide an information code that enables excision and decoding, by means of mathematical calculation, of even a data recording code portion that has high recording density and that is thus difficult for excision and decoding by only color component analysis because of increased number of colors or reduced cell size.

### Means for Solving the Problems

In order to achieve the above descried purpose, the present invention provides an information code which comprises an excision code portion based on a code system that allows easy excision, by means of color component analysis, of a code area from an image data containing the code area and a data recording code portion which is capable of recording target electronic data in high recording density and which can improve recording density of the data recording code portion by increasing the number of colors and/or reducing the cell size, by making possible extraction from and decoding of the data recording code portion using mathematical calculation not solely depending on the color component analysis, by decoding the excision code portion.

### Advantageous Effect of the Invention

As is clear from the above-mentioned explanations, the present invention as hereinabove defined provides the effects enumerated below.

(1) The information code comprises an excision code portion based on a code system which allows easy excision, by means of color component analysis, of a code area from an image data containing the code area and a data recording code portion which is capable of recording target electronic data in high recording density and can improve recording density of the data recording code portion by increasing the number of colors and/or reducing the cell size, by making possible extraction from and decoding of the data recording code portion using mathematical calculation not solely depending on the color component analysis, by decoding the excision code portion and, therefore, both high recording density and restoration accuracy can be retained.

(2) Claim 2 has the same effect as the above (1), and it can also improve recording density of the data recording code portion by decoding of the excision code portion.

### BRIEF DESCRIPTION OF THE DRAWINGS

FIG. 1 is a front view showing a first preferred embodiment of the present invention;

FIG. 2 is an explanatory view showing the first preferred embodiment of the present invention;

FIG. 3 is an explanatory view showing a method to excise an information code area by using an excision code;

FIG. 4 is a method to restore an excised data recording code; and

FIG. 5 is an explanatory view showing disadvantages of a color code.

### EXPLANATION OF REFERENCE NUMERALS

1: Information code

2: Excision code portion

3: data recording code portion

### BEST MODE FOR CARRYING OUT THE INVENTION

Preferred embodiments of the present invention will now be described in detail below referring to the accompanying drawings.

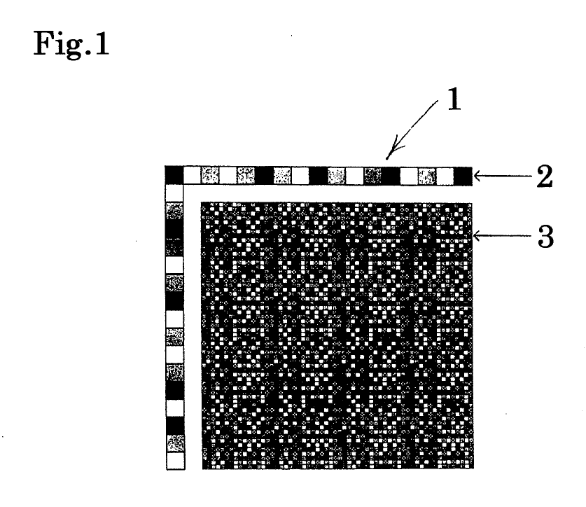

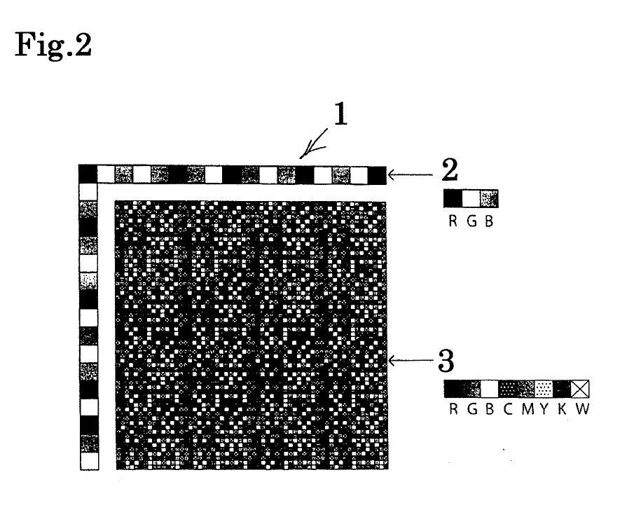

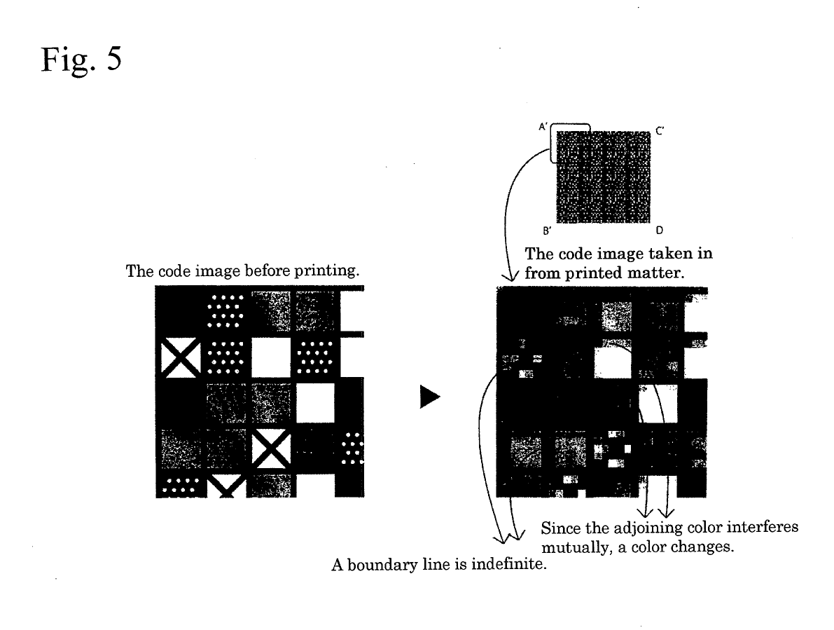

A first preferred embodiment of the present invention is illustrated in FIGS. 1 to 5. An information code 1 is comprised of an excision code portion 2 based on a code system which allows easy excision, by means of color code analysis, of a code area from an image data containing the code area and a data recording code portion 3 which is capable of recording target electronic data in high recording density, and can improve recording density of the data recording code portion by increasing the number of colors and/or reducing the cell size, by making possible extraction from and decoding of the data recording code portion 3 using mathematical calculation not solely depending on color component analysis, by decoding the excision code portion 2.

The above-described excision code portion 2 has two roles; one being to serve as a reference for easy excision of an information code from image data which contains the information code therein, and the other being to encode information minimally required for excision of the data recording code portion 3 as well as for analysis of the number and composition of the cells. To fulfill those roles, the code system to be used has to be of high excision and restoration accuracy. Limiting the number of colors to be used to two or three, e.g. black-and-white, RGB or CMY, in order to maintain enough color difference, contributes to lessen the effect of color fading, uneven printing or illumination light, whereas enlarging the cell size makes cell shape identification easier. A possible alternative method for the excision code portion 2 is to use code systems like proven QR code or the Japanese Published Unexamined Application 2008-27029, to fulfill the function.

Role of the data recording code portion 3 is to serve as a code system that prioritizes recording efficiency for electronic data. Therefore, ideally, a maximum number of colors has to be used within a range to maintain the target decoding accuracy, and the cell size has to be reduced within a range to be reproducibly printed.

### (Code Preparation Method and Encoding Method)

A code to be used for the excision code portion 2 need not to be limited but can be arbitrary one such as bar-code, QR code, color code, etc. However, assume that encoding and decoding methods disclosed in the Japanese Published Unexamined Application 2008-27029 are applied here as examples. Assume that the data recording code portion employs a typical encoding method which assigns a color to a bit pattern, and is explained utilizing FIG. 1 as an example.

The excision code portion 2 has been encoded with one or more data therein, the data of which are used for excision and decoding of the data recording portion 3, including the number which represents the number of cells on one side of the data recording code portion 3, number of colors, data code position, vertical and horizontal identification, cell size, code shape, etc.

Data recording code portion 3 can represent eight different patterns on a cell if eight colors are used and, therefore, in case target electronic data to be converted to code is replaced with binary data that is represented as a 0-and-1signals, one cell can represent a 3-bit array. Now each of the eight colors is assigned to a 3-bit-equivalent array pattern. For example, assuming that the colors to be used comprise RGBCMYKW, it is assumed that the following RGB values are assigned:

### 001=R (R255, G000, B000)

### 010=G (R000, G255, B000)

### 100=B (R000, G000, B255)

### 011=C (R000, G128, B255)

### 110=M (R255, G000, B128)

### 101=Y (R255, G255, B000)

### 000=K (R000, G000, B000)

### 111=W (R255, G255, B255)

Target electronic data may be compressed, instead of being directly code-converted, by using an ordinary data-compression technique such as ZIP or LZH in order to improve recording efficiency.

The target electronic data are converted to a bit pattern train, and it is divided in every 3-bits, and is further converted to color cells in accordance with the above color assignment table.

In order for the cells of the code to be represented to have the same number of cells vertically as well as horizontally, the code is composed in such a way that a new cell line is started for each number of cell calculated by rounding-up a numeral after the decimal point in a square root of (the byte size of an compressed file×8÷3).

The excision code portion 2 and the data recording code portion 3 are laid out in such a way that they are in a certain positional relationship with the excision code portion 2 serving as a reference, so that the data recording code portion 3 can be located. In this case, the excision code portion 2 is defined as a 90°-angled L-letter shape, and is located in such a way that it surrounds the data recording code portion 3, with a distance corresponding to one cell of the excision code portion left as locating to the top and left sides of the data recording code portion 3.

### (Recording Method on Print Medium)

Then, color management (color information conversion suitably adjusted to specifications of a printing machine or a printer) is made beforehand in order to keep the color unchanged for assignment to the information code 1 and for printing. This is because the color of the information code 1 generated on an electronic medium is represented in RGB values, the data of which has to be converted to CMYK values for printing and because a usual conversion method varies the color even in the same data with a change made depending on a difference between papers, printing machines (including printers) or print colorstandards, resulting in such that correct color information cannot be rendered when being printed on the print medium. Print color standards differ from country to country. Those for Japan are Japan Color, JMPA, etc. Successful printing can be achieved with color unchanged by converting RGB values to CMYK values according to the corresponding print colorstandard; Japan Color, JMPA, etc. There is a risk that a difference of printing machines (including printers) and/or sheets of paper to be used may result in a difference in printed color. A useful solution to this problem is to comprehend characteristics of the paper and/or the printing machine based on a color chart (colorimetric print piece) printed out from the printing machine on the paper, from which a database is created, and based on which RGB values are converted to CMYK values. A method for converting RGB values to CMYK values is such that, based on data of printstandards, paper, and characteristics of printing machine, a profile (data which indicates RGB values and corresponding CMYK values for conversion) is made in advance, by which RGB values are automatically converted to CMYK values, the data being processed by the profile for automatic conversion to corresponding print standard. By printing the converted data, the same color can be reproduced on the printing surface. Therefore decoding accuracy of the information code 1 is improved.

### (Code Decoding Method)

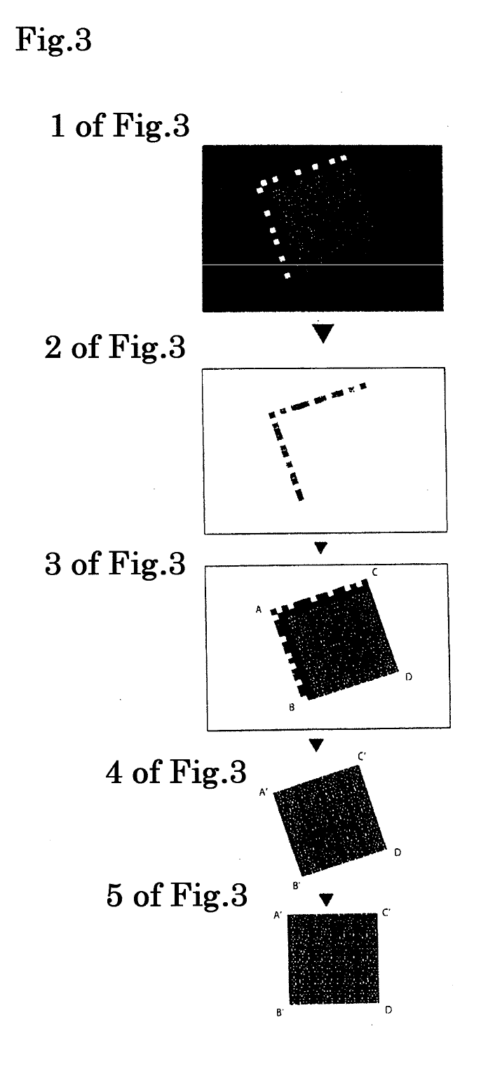

A decoding method of the excision code 2 is now described using FIG. 3. In case of FIG. 3, the cell size is large and the number of colors is limited for excision by the conventional analysis of color components. The decoding method of the excision code 2 is dependent on a decoding method of the code system to be used.

As illustrated in sections 1 and 2 of FIG. 3, the excision code 2 is excised.

As illustrated in section 3 of FIG. 3, based on points A, B and C of the excision code portion 2, point D is calculated and an information code area is excised.

As illustrated in section 4 of FIG. 3, according to a program (for example, point B′ is calculated based on a rule that it locates at twice the length of one side of the cell of excision code 2 in the direction from point B to point D) todefine the area of the data recording code portion 3 with the points A, B and C of the excision code portion 2, points A′, B′ and C′ are calculated and the data recording code portion 3 is excised.

As illustrated in section 5 of FIG. 3, the image data is rotated to behorizontal with A′-C′ being the top side thereof. By following the steps as illustrated in sections 1 to 5 of FIG. 3, it is possible to excise the data recording code portion 3, in which positional relationship to the excision code portion 2 is utilized. Judgment by color components allows the data recording code portion 3 to be extracted even when discrimination of an area of the data recording code portion 3 from other areas is difficult.

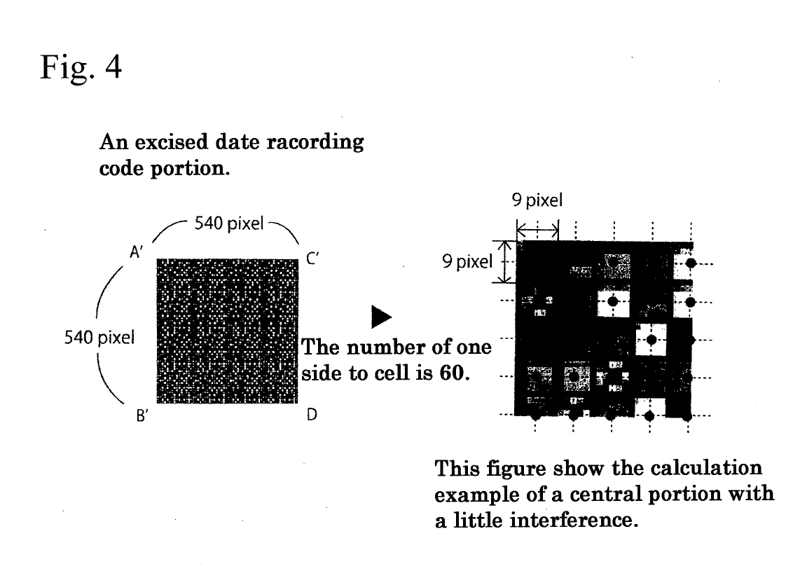

The most ideal way to identify color of each cell is to identify the center position of the each cell, where effect of color component mixture is minimal, and identify the color based on pixels around the center. In the present invention, the number of cells per code side has been obtained at the time of decoding the excision code 2 and, based on the number, the center of each cell of the data recording code portion 3 can be calculated. For example, as illustrated in FIG. 4, it is assumed that a number that represents the number of cells per data recording code side has been obtained as 60 by decoding the excision code 2 when an excised data recording code has 540×540 pixels. Based on an thought that the cells are evenly positioned, it is understood that each cell is composed of 9×9 pixels. It is easily understood that the center of the 9×9 pixels is at a position of 5×5 pixels inward from the end of each cell. In another way, because the data recording code portion 3 has been excised as described above, and unnecessary data has been eliminated, it is also possible to locate the central point by means of a change in color component value of the data recording code portion 3. The central point has the highest probability of retaining assigned color components, and thus, for example, if an image of the data recording code portion 3, being excited as described above, is represented as a wave pattern on a 0-100 scale, wherein 100 indicates the closest to the component value of the assigned color while 0 indicates the farthest from that, a pixel at the peak of the wave pattern is considered to have a high probability of the central point of a cell to which a color has been assigned. When the mountain peaks of the wave pattern of each assigned color are plotted on an emergence distribution chart, it is understood that central points emerge under constant regularity where cells even with different colors are arrayed. An interval between the adjacent mountains can be considered as that between the central points of the adjacent cells, so that a point difficult to identify the mountain of the wave pattern can be found by mathematical calculation of the interval.

Color of each cell is identified based on color information of a pixel at the central point or pixels within a certain area therefrom. A method for this identification can use typical color analysis. For example, assuming that a color is identified based on color information of 3×3=9 pixels when using one pixcel at the central point and its immediate surroundings, an RGB value of each pixel is as follows:

### A (R255, G010, B004)

### B (R245, G006, B002)

### C (R250, G020, B020)

### D (R239, G000, B000)

### E (R248, G013, B014)

### F (R251, G003, B006)

### G (R254, G010, B001)

### H (R255, G002, B000)

### I (R255, G001, B004)

If color of each pixel is judged as the one closest to color components of RGBCMYKW that have been assigned for encoding, then the color can be identified as R (R255, G000, B000). Assuming that the cell is represented as R, 001 can be obtained by converting the cell to a bit pattern column according to theencoding assignment chart. A pixel at the central point or pixels within a certain area therefrom are least affected by color mixture and, therefore, this can be the most accurate color identification method. This method furthermore allows minimizing the pixel information to be used for analysis, so that it provides high calculation efficiency while not requiring high resolution.

By converting cells in turn by the aforementioned method, bit pattern array of corresponding electronic data can be obtained. Then, by assigning extensions representing the kind of files of corresponding data, which have been obtained at the time of decoding the excision code portion, target electronic data can be obtained. As far as a compressed file is concerned, decoding is made in accordance with a decoding method of the compression technique being used.

### INDUSTRIAL APPLICABILITY

The present invention is applicable to the industry where an information code having both recording density and restoration accuracy retained is used.

1. An information code comprising an excision code portion based on a code system which allows easy excision, by means of color component analysis, of a code area from an image data containing the code area, and a data recording code portion which is capable of recording target electronic data in high recording density, and is able to improve recording density of the data recording code portion by increasing the number of colors and/or reducing the cell size, by decoding of the excision code portion making possible also using mathematical calculation not solely depending on color component analysis.

2. The information code according to claim 1, wherein the excision code portion has two or more data encoded therein including data code position, vertical and horizontal identification, code identification, cell size, number of cells, number of colors and code shape.
